(19) United States
(12) Patent Application Publication
(10) Pub. No.: US 2004/0162390 A1
(43) Pub. Date: Aug. 19, 2004

(54) Copolymer/polyol fine-rubber blends by reactive processing with phenol-aldehyde condensate

(76) Inventors: Werner Obrecht, Moers (DE); Norbert Steinhauser, Monheim (DE); Mario Vierle, Munchen (DE); Oskar Nuyken, Munchen (DE)

Correspondence Address: Bayer Corporation, Patent Department, 100 Bayer Road, Pittsburgh, PA, 15205-9741, US

(21) Appl. No.: 10/479,425

(22) PCT Filed: May 24, 2002
(86) PCT No.: PCT/EP02/05704

(30) Foreign Application Priority Data
Jun. 6, 2001 (DE) 101 27 402.5

(51) Int. Cl. C08C 19/00; C08L 19/00

(52) U.S. Cl. 525/133

(57) ABSTRACT

The present invention is directed to blends of a copolymer and a polyolefin rubber having good mechanical properties. According to the present invention, the polymer blend can be obtained by a one-stage melt compounding process. The polymer blends of the present invention are useful in the production of molded

The present invention relates to blends of a copolymer and a polyolefin rubber with very good mechanical properties, that can be obtained by one-stage melt compounding, a process for their production and their use for the production of moulded bodies.

Copolymer/rubber blends are produced to achieve improvements in the mechanical properties of the corresponding materials in comparison with the pure components. Depending on the composition of the blend, rubber-modified thermoplastics or thermoplastic elastomers are obtained. Materials of this kind are used in domestic appliances, electrical/electronic devices, motor vehicles and in medical engineering.

Copolymer/rubber blends, such as e.g. AES (SAN/EP(D)M blend), are produced by the solution, emulsion or melt blending process. In the solution and emulsion processes, a radical copolymerisation of styrene- and acrylonitrile monomers takes place in the presence of dissolved or emulsified rubber. In addition to the formation of styrene-acrylonitrile copolymer, styrene-acrylonitrile copolymer chains are simultaneously grafted onto the rubber. These graft copolymers act as phase mediators in the SAN/rubber blend and are necessary to achieve a morphology and phase binding of the rubber particles dispersed in the SAN matrix that is advantageous for the blend properties. The disadvantage of such processes is the necessity of removing the solvent or emulsion medium, which entails considerable industrial processing expenditure or the formation of waste water.

In the melt blending process, the SAN/rubber blend is produced without solvent or emulsion medium, above the glass transition or melting temperature of the components in a kneader or extruder. Here too, a phase mediator must be present to set a morphology and phase binding favourable for the product properties. This phase mediator must either be added separately when producing the blend or formed in situ during blend production. The disadvantage of adding a phase mediator separately, is that it must be synthesised in a prior production step.

The phase mediator can be formed in situ by using functionalised blend components, which react with each other during blend production to form graft- or block copolymers. Thus, maleic acid anhydride-functionalised EPDM, for example, can react with NH₂-functionalised SAN to form SAN-EPDM graft copolymer, which acts as a phase mediator in the blend (disclosed inter alia in C. Pagnoulle, R. Jérôme, Polymer 2001, 42, 1893). Here too, there is the disadvantage that the functionalised blend components must be produced separately. The same applies for the method disclosed in U.S. Pat. No. 4,278,572. Here, in a prior synthesis step, polyolefins are reacted with phenol-formaldehyde condensates (methylolphenol oligomers) in the presence of a Lewis acid to form methylolphenol-modified polyolefins. The use of EPDM as a polyolefin component is expressly excluded, as EPDM reacts with phenolformaldehyde condensate in the presence of a Lewis acid by crosslinking. These methylolphenol-modified polyolefins are then reacted with a second blend component in the next synthesis step to form the desired blend. This method has the disadvantage that two synthesis steps are required to produce the blend and that SAN/polyolefin rubber blends in which the polyolefin rubber contains at least one diene component, such as e.g. EPDM, cannot be produced in this way.

It has now been found, surprisingly, that copolymer/polyolefin rubber blends can be produced in only one synthesis step by melt blending copolymers and polyolefin rubber adding small quantities of a phenol-aldehyde condensate and a Lewis acid, and that commercial copolymer and polyolefin rubber types that are not separately functionalised can be used as well as those polyolefin rubbers that contain a diene component (such as for example EPDM). The copolymer/polyolefin rubber blends produced in this way have significantly better mechanical properties than copolymer/polyolefin rubber blends that are produced without the addition of phenol-aldehyde condensate and Lewis acid.

The present invention thus provides copolymer/polyolefin rubber blends that can be obtained by compounding the following components:

A) one or more copolymers and

B) one or more polyolefin rubbers, the weight ratio of A to B being 40:1 to 1:40, preferably 10:1 to 1:10,inparticular5:1 to 1:5, and

C) 0.25 to 5 wt. %, preferably 0.5 to 2.5 wt. % in relation to the total quantity, of a phenol-aldehyde condensate and

D) 0.05 to 2 wt. %, preferably 0.1 to 1 wt. %, in particular 0.15 to 0.5 wt.% in relation to the total quantity of a Lewis acid.

Copolymers of styrene and acrylonitrile in a weight ratio of 95:5 to 10:90, preferably 80:20 to 60:40, wherein styrene and/or acrylonitrile can be wholly or partly replaced by α-methylstyrene and/or methylmethacrylate are suitable as copolymer component A); optionally up to 30 wt. % proportionally (in relation to component A)) of another monomer selected from the group containing maleic acid anhydride, maleic acid imide, N-(cyclo)-alkylmaleic imide, N-(alkyl)-phenylmaleic imide can also be used.

Suitable styrene-acrylonitrile copolymers have sufficiently high molecular weights to form thermoplastic properties, preferably from ca 40,000 to 200,000 g/mol, in particular 50,000 to 150,000 g/mol determined by gel permeation chromatography (GPC).

Details of the production of these copolymers are disclosed for example in DE-A 2 420 358 and DE-A 2 724 360. Copolymers produced by mass or solvent polymerisation and by suspension polymerisation have proved particularly reliable.

Suitable polyolefin rubbers B) can be fully amorphous or partially crystalline and composed of one or more monomers. Ethylene, propylene, linear and branched 1-alkenes with 4 to 12 C atoms, cyclopentene, cyclooctene, styrene, methylstyrene, norbornene, conjugated dienes such as isoprene and butadiene, non-conjugated dienes with 5 to 25 C atoms such as penta-1,4-diene, hexa-1,4-diene, hexa-1,5-diene, 2,5-dimethylhexa- 1,5-diene, 7-methyl- 1,6-octadiene, 1,7-octadiene and octa-1,4-diene, cyclic dienes such as cyclopentadiene, cyclohexadiene, cyclooctadiene and dicyclopentadiene and alkenylnorbornenes such as 5-vinyl-2-norbomene, 5-ethylidene-2-norbornene, 5-butylidene-2-norbornene, 2-methallyl-5-norbomene and 2-isopropenyl-5-norbornene and also tricyclodienes such as 3-methyl-tricyclo-(5.2.1.0.2.6)-3,8-decadiene or mixtures thereof, for example, can be used as monomers for the production of these polyolefin rubbers.

Preferred diene monomers for the production of polyolefin rubbers are hexa-1,5-diene, 5-ethylidene norbornene, 5-vinyl-2-norbornene, butadiene, isoprene and dicyclopentadiene. The diene content of the rubbers is generally 0.5 to 50, preferably 1 to 12 wt. %, in particular 2 to 8 wt. % in relation to the total weight of the rubber.

Examples of suitable polyolefin rubbers are polybutadiene (BR), polyisoprene, polyisobutene, isobutene-isoprene rubber (IIR), ethylene-propylene rubber (EPM) and ethylene-propylene-diene rubber (EPDM).

Preferred polyolefin rubbers are ethylene-propylene (EPM) or ethylene-propylene-diene (EPDM) rubbers.

Block polymers with rubbery-elastic properties, in particular for example di- (A-B) and tri- (A-B-A) block copolymers are also suitable as polyolefin rubbers. Block copolymers of the type A-B and A-B-A show the typical behaviour of thermoplastic elastomers. Preferred block copolymers of the type A-B and A-B-A contain one or two vinyl aromatic blocks (preferably based on styrene) and a rubber block (preferably a diene-rubber block, in particular a polybutadiene block or polyisoprene block). Suitable block copolymers of the type A-B and A-B-A are e.g. disclosed in U.S. Pat. No. 3,078,254, U.S. Pat. No. 3,402,159, U.S. Pat. No. 3,297,793, U.S. Pat. No. 3,265,765, U.S. Pat. No. 3,594,452 and GB-A 1 264 741. Examples of typical block copolymers of the type A-B and A-B-A are polystyrene-polybutadiene, polystyrene-poly(ethylene-propylene), polystyrene-polyisoprene, poly-(a-methylstyrene)-polybutadiene, polystyrene-polybutadiene-polystyrene, polystyrene-poly(ethylene-propylene)-polystyrene, polystyrene-polyisoprene-polystyrene and poly-(α-methylstyrene)-polybutadiene-poly-(α-methylstyrene) and block copolymers in which the olefinic double bonds of the polybutadiene- or polyisoprene-block are partly or fully hydrogenated. Of these, styrene-butadiene rubber (SBR) is preferred.

Suitable phenol-aldehyde-condensates C) (methylolphenol-oligomers) are produced by condensation of unsubstituted phenol or phenol substituted with linear or branched alkyl substituents or halogen substituents, preferably p-(1,1,3,3-tetramethyl-butyl)phenol, with an aliphatic or aromatic aldehyde, preferably formaldehyde, acetaldehyde, propionaldehyde, butyraldehyde or benzaldehyde, in particular formaldehyde. The phenol aldehyde condensates contain mixtures of methylolphenol oligomers with up to 20 benzene rings. Examples of suitable compounds are disclosed in U.S. Pat. No. 2,972,600, U.S. Pat. No. 3,093,613, U.S. Pat. No. 3,211,804, U.S. Pat. No. 3,287,440 and U.S. Pat. No. 3,709,840. Condensates of branched alkyl-substituted phenol and formaldehyde are preferred in particular.

Metal- and transition metal-halogenides such as e.g. BF₃, BCl₃, SnCl₂, SnCl₄, ZnCl₂, ZnBr₂, TiCl₃, TiCl₄, AlCl₃, FeCl₂, FeCl₃, FeBr₂, AlCl₃, AlBr₃ are suitable as Lewis acids D). Suitable Lewis acids are also disclosed in U.S. Pat. No. 4,121,026. The corresponding metal oxides or hydroxides in conjunction with a suitable source of halogen such as e.g. polychloroprene or PVC can also be used, which form Lewis acids in situ during melt blending. Tin and zinc halogenides, in particular SnCl₂ and ZnCl₂ are preferred in particular.

The blend can be produced with any apparatus suitable for the production of polymer mixtures, such as e.g. kneaders, extruders, rollers or combinations thereof. The components for the production of the blend can be added in any order. However the component which makes up the largest proportion by quantity in the blend, i.e. copolymer or polyolefin rubber, is preferably provided first. It is also possible to mix two or more components before the actual production of the blend. The temperature of blend production should be above the melting point or glass transition temperature of the main components. A temperature range of 140 to 240° C., in particular 160 to 220° C., is preferred. The total mixing time and the time between the addition of individual components should be chosen in such a way, that sufficient intermixing can take place and is generally from 1 to ca 10 minutes.

The reaction is normally stopped by cooling. With this procedure, acid-catalysed ageing reactions cannot be ruled out. For this reason, it is useful to neutralise the acid or Lewis acid at the end of the reaction. Inorganic or organic acid traps can be used for this. Suitable inorganic acid traps are for example metal oxides such as calcium oxide, magnesium oxide, zinc oxide or lead oxide. Organic acid traps are organic bases such as e.g. primary, secondary or tertiary amines, acetates, carboxylates. Masked amines such as e.g. carbamates, are also suitable. Amides, polyamides, ureas, thiorureas and guanidine are also suitable.

The polymer blends according to the invention can contain other additives, such as for example agents to prevent thermal decomposition, thermal crosslinking and damage by ultra-violet light, plasticisers, flow and processing auxiliaries, flame-retarding substances, mould lubricants and mould release agents, nucleation agents, anti-statics, stabilisers and colours and pigments.

The blends according to the invention are suitable for the production of moulded bodies by extrusion or injection moulding.

### EXAMPLES

Components

A) SAN M 60 (styrene-acrylonitrile copolymer, Bayer AG Leverkusen, Germany)

B/1) EPT 2370 (EPDM with an ethylidene norbornene content of ca 3.0 wt. %, Bayer AG Leverkusen, Germany)

B/2) EPT 2070 (EPDM with an ethylidene norbornene content of ca 0.6 wt. %, Bayer AG Leverkusen, Germany)

B/3) EPT 6650 (EPDM with an ethylidene norbornene content of ca 6.5 wt. %, Bayer AG Leverkusen, Germany)

C) Phenol-formaldehyde condensate type Resin SP-1045 (Schenectady Europe Ltd., GB)

D) SnCl₂.2H₂O for synthesis (Merck KGaA, Darmstadt, Germany)

### Example 1

28.3 g EPDM (type EPT 2370) and 0.9 g phenol-formaldehyde condensate are added to the mixing chamber of a laboratory kneader of the Haake Rheocord System type (Rheomix 600 p mixing chamber with cam-type rotors, effective chamber volume 78 cm³) pre-heated to 140° C. Kneading is carried out for 3.5 min at a rotor speed of 100 rpm. 28.3 g SAN are then added and kneading is continued for a further 2 minutes. 120 mg SnCl₂.2H₂O are then added and kneading is carried out for 5 min, during which the temperature increases to 205° C. Finally the product is removed from the mixing chamber, pressed into a sheet on a heating plate and standard bars are stamped out for tensile and elongation measurements. The values for breaking energy, tensile stress and elongation at break are determined according to DIN 53504.

The blends for examples 2 to 6 are produced in the same way. The results are summarised in Table 1.

TABLE 1

| (figures in wt. %) | Ex. 1 | Ref. 1 | Ex. 2 | Ref. 2 | Ex. 3 | Ref. 3 |
|---|---|---|---|---|---|---|
| A | 49.1 | 50 | 49.1 | 50 | 49.1 | 50 |
| B/1 | 49.1 | 50 | — | — | — | — |
| B/2 | — | — | 49.1 | 50 | — | — |
| B/3 | — | — | — | — | 49.1 | 50 |
| C | 1.5 | — | 1.5 | — | 1.5 | — |
| D | 0.2 | — | 0.2 | — | 0.2 | — |
| Breaking | 1186 | 31 | 78 | 10 | 40 | 0 |
| energy [mJ] | | | | | | |
| Elongation at | 8.1 | 0.6 | 10.1 | 1.6 | 3.3 | 0 |
| break [%] | | | | | | |

The examples in Table 1 show that, when using the phenol-aldehyde condensate to produce the blend, significantly better values are obtained for breaking energy and elongation at break than with blends that are produced without using the phenol-aldehyde condensate. These improved values for breaking energy and elongation at break are achieved using EPDM types that have very low (Example 2), average (Example 1) and high (Example 3) diene contents.

1. Polymer blends obtainable by compounding the following components:
A) one or more copolymers and
B) one or more polyolefin rubbers, the weight ratio of A to B being 40:1 to 1:40, and
C) 0.25 to 5 wt. % in relation to the total quantity of the polymer blend, of a phenol-aldehyde condensate and
D) 0.05 to 2 wt. % in relation to the total quantity of the polymer blend of a lewis acid:

2. Polymer blend according to claim 1, wherein the weight ratio of A) to B) is 10:1 to 1:10.

3. Polymer blend according to claim 1 or 2, wherein the proportion of component C) is 0.5 to 2.5 wt. % in relation to the total quantity.

4. Polymer blend according to one or more of the previous claims, wherein the proportion of Lewis acid D) is 0.1 to 1 wt. % in relation to the total quantity.

5. Polymer blend according to one or more of the previous claims, wherein component A) is a copolymer of styrene and acrylonitrile, wherein styrene and/or acrylonitrile can be wholly or partially replaced by α-methyl styrene and/or methylmethacrylate and which can contain 0 to 30 wt. % (in relation to A) of another monomer selected from the group containing maleic acid anhydride, maleic acid imide, N-(cyclo)-alkylmaleic imide and N-(alkyl)-phenylmaleic imide.

6. Polymer blend according to one or more of the previous claims wherein component C) is a condensate of alkyl-substituted phenol and formaldehyde.

7. Polymer blend according to one or more of the previous claims, wherein the Lewis acid D) is SnCl₂ or ZnCl₂ or a mixture of these.

8. Process for the production of polymer blends, wherein
A) one or more copolymers and
B) one or more polyolefin rubbers, the weight ratio of A to B being 40:1 to 1:40, and
C) 0.25 to 5 wt. % in relation to the total quantity of a phenol-aldehyde condensate and
D) 0.05 to 2 wt. % in relation to the total quantity of a Lewis acid,
are compounded at 140 to 240° C.

9. Use of polymer blends according to any one of claims 1 to 7 for the production of moulded bodies.

10. Moulded bodies obtainable from polymer blends according to any one of claims 1 to 7.
